(19) United States
(12) Patent Application Publication
(10) Pub. No.: US 2006/0081800 A1
(43) Pub. Date: Apr. 20, 2006

(54) Actuator for operating a valve in process automation

(75) Inventors: Werner Riester, Mullheim (DE); Henrik Newerla, Neuenburg (DE)

Correspondence Address: BACON & THOMAS, PLLC, 625 SLATERS LANE, FOURTH FLOOR, ALEXANDRIA, VA, 22314, US

(73) Assignee: Auma Riester GmbH + Co. KG, Mullheim (DE)

(21) Appl. No.: 11/235,420

(22) Filed: Sep. 27, 2005

(30) Foreign Application Priority Data
Oct. 1, 2004 (DE) DE102004048366.3

(51) Int. Cl. F16K 31/02

(52) U.S. Cl. 251/129.01

(57) ABSTRACT

A actuator for operating a valve in process automation. The actuator includes a separately operable, adjustment wheel and an electric motor having at least a stator and a rotor. The stator and rotor are associated with predetermined regions of an output shaft. A valve connection is provided in a first end region of the output shaft for coupling the actuator to the valve. The adjustment wheel is arranged in a second end region of the output shaft.

### FIELD OF THE INVENTION

The invention relates to an actuator for operating a valve in process automation. The valve is, preferably, a control element, e.g. a globe-, gate-, throttle- or butterfly-valve. Depending on the control element, the operating, or adjusting, process involves a rotary, translatory or pivoting motion. Electric actuators for valves must, for such purposes, be designed to be able to transmit high torques (30-500,000 Nm) at low rotational speeds (4-180 RPM), with it being necessary that the transmitted torque remain very constant over small angles of rotation.

### BACKGROUND OF THE INVENTION

Electric actuators for regulating and/or controlling valves have become an integral part of process automation. In the case of known actuators, torque transfer between electric motor and valve occurs via a reduction transmission, which, depending on application, is embodied in many different ways. The reduction transmission is necessary, in order to convert the high rotational speed of the electric motor into the desired, very constant, output rotational drive speed for operating the valve. Every suitable type of transmission can be used for the reduction transmission, examples being a bevel or spur transmission, a worm transmission, a superposition (override drive) transmission or a lever transmission. Actuators are available from the assignee for the widest variety of applications. For instance, the torque range in the case of rotationally driving actuators reaches up to a torque of 32,000 Nm; in the case of part-turn actuators, torques up to 360,000 Nm can be realized.

In the following, the design principles of a known actuator will be described: For reducing the rotational speed of the electric motor to the output rotational speed, with which the valve will be operated, a planetary transmission is combined with a worm transmission, including worm shaft, worm gear (worm, for short) and meshing worm wheel. In order to assure that the worm transmission remains in the desired rest position when the electric motor is not moving, the worm transmission has a self-locking feature. Worm shaft and hollow output shaft with worm wheel run, usually, in ball, or dry-sliding, bearings.

The worm is arranged on the worm shaft slidably between two measuring spring-packages, so that the worm undergoes a translatory movement relative to the worm shaft when a torque to be transferred is present. This shifting, which is a measure for the torque to be transferred, is forwarded to a control unit. The interior of the housing containing the transmission is filled with lubricant, so that maintenance-free gearbox operation is assured over longer periods of time.

Depending on the structural characteristics of the valve, the rotationally driving actuator must be turned off in the end positions, either on the basis of travel distance or on the basis of torque. For this purpose, usually two independent measuring systems are provided in the control unit, namely a travel-distance switching system and a torque switching system, which measure, respectively, the distance of actuator travel and the torque present at the output shaft. The reaching of a desired position is signalized to the control system through the use of a switch, and the control system, in turn, turns off the electric motor.

In order to meet a safety standard specified for process automation, it must be possible to operate the actuator in an emergency via a separately movable, adjustment wheel. This adjustment wheel is, moreover, also used, for example, in the process of installing the actuator for a new task. The adjustment wheel is usually a hand wheel, which is manually operated by operating personnel, whereby the valve is brought into a desired position.

For the purpose of separating hand operation from motor operation, a coupling mechanism is provided. The coupling mechanism is usually so embodied and/or arranged, that, in motor-driven operation, the rotor is directly coupled with the output shaft and the adjustment wheel is uncoupled, while, in hand operation, the output shaft is coupled with the adjustment wheel and the rotor is uncoupled. In this way, a separation between motor operation and hand operation is achieved. Especially, the coupling mechanism is, furthermore, embodied in such a manner that the adjustment wheel is automatically uncoupled from the rotor shaft, as soon as the actuator starts being motor driven—motor operation thus has preference over hand operation.

The above-described actuator technology has proven itself well in practice. Certain disadvantages show themselves, however, in that, to convert the rotational speed of the motor to the desired output rotational speed, a transmission is required. This transmission involves certain costs, it requires a certain space, and it is, due to the required lubrication, not maintenance-free.

### SUMMARY OF THE INVENTION

Therefore, an object of the invention is to provide an actuator distinguished by its high responsiveness and by being largely maintenance free.

The object is achieved by the following features: The actuator of the invention has a separately operable adjustment wheel and an electric motor with at least one stator and one rotor, wherein the stator and the rotor are associated with predetermined regions of an output shaft, wherein, in a first end region of the output shaft, a valve connection is provided for coupling the actuator to the valve, and wherein the adjustment wheel is arranged in a second end region of the output shaft.

According to the invention, the electric motor thus concerns a direct drive, or direct adjuster, in which the output shaft is directly and immediately connected with the control element, e.g. the valve; therefore, there is no intermediately placed transmission of some type for reducing the rotational speed of the motor to the rotational speed of the output for operating the control element. The exact positioning of the actuator is accomplished via an appropriate electrical activation of the electric motor.

The solution of the invention has the following advantages, as compared with the known solution using a reduction transmission:
The reduction transmission between electric motor and valve is saved. This provides both cost savings and a lessened space requirement, so that the actuator of the invention can be embodied very compactly.
For the exact registering of torque, it has long been necessary to place the worm transmission between two spring packages, e.g. disc springs, having a predetermined spring force. Additionally, a travel registering unit serves for determining the particular position of the output shaft. Since in the solution of the invention the transmission is completely omitted, this travel registering unit is also avoided. As will be described in greater detail below, the registering of torque in the actuator of the invention is accomplished in the simplest case via a measurement and evaluation of the motor current, since, in this case, the motor current is proportional to the torque.
An extra mechanical locking device for the electric motor, for assuring that the electric motor does not turn, when the adjustment wheel/hand wheel is operated, is omitted. The actuator of the invention exhibits, in effect, an intrinsic self-locking. To this end, the coils of the coil arrangement are short circuited by the control in the case of a separate operation of the output shaft via the adjustment wheel. If, now, the adjustment wheel is actuated, then, in the stator of the electric motor, a voltage is induced, which opposes the torque exerted on the adjustment wheel.
Due to the long-needed transmission for reducing the rotational speed of the electric motor, for example, from e.g. 3000 RPM to a low rotational speed, the known actuators have a relatively poor mechanical efficiency. In the case of the direct drive of the invention, the mechanical efficiency lies markedly higher than in the case of the known actuators with interposed transmission.
As already indicated, the transmissions used in the case of the known actuators require lubrication—they are not maintenance free. Since, in the case of the direct drive, the transmission is omitted, it does not need lubrication. This means automatic avoidance of the problem that lubricant can possibly escape from the transmission casing into the process, a factor which is naturally of grave concern in the foods, chemicals, and pharmaceuticals industries. Moreover, it is then also assured that no lubricant can reach the environment, which is very important for environmental reasons.

Preferably, the electric motor is one which can be directly coupled with the output shaft and which develops a high torque both at low rotational speeds and at standstill. Motors with these characteristics are generally referred to as torque-motors.

In principle, the electric motor can, however, be any kind of electric motor. Examples which can be mentioned are electric motors in which the rotor is an internal rotor or an external rotor. Independently of the aforementioned motor types, either the magnet arrangement or the coil arrangement is provided on the rotor. Another option is to embody the electric motor without a magnet arrangement; in this case, the rotor must already intrinsically exhibit the properties of the magnet arrangement.

Of course, it is also possible to use an electric motor, in which the rotor is embodied as a disc rotor having at least one disc.

In order to know the exact angular position of the electric motor, an advantageous further development of the actuator of the invention associates a position sensor with the output shaft. The position sensor can be any device which is suitable for determining angular position. Thus, for instance, it can be an absolute sensor or an incremental sensor.

In principle, when the application permits, the actuator can be connected directly to the current supply just long enough to adjust the valve to the desired position. However, it is especially advantageous in connection with the actuator of the invention to effect the activation/modulation of the electric motor via a control, which operates the electric motor, and thus the valve, based on information supplied by the position sensor, until the particular desired position is reached.

As already mentioned above, the control short-circuits the coils of the coil arrangement in the case of a separate operating of the output shaft via the adjustment wheel. This assures that the rotor, and thus the electric motor, undergoes an intrinsic self-locking.

In some cases of application, it is desired that the adjustment wheel does not turn during motor operation. Conversely, it is required that, in the case of separate operation of the hand wheel, the electric motor should not be caused to rotate. In order to assure this combination of features, an advantageous embodiment of the actuator of the invention provides a coupling mechanism, which is embodied and/or arranged in such a manner that, during motor operation, the rotor is directly coupled with the output shaft and the adjustment wheel is uncoupled, and that, in the case of separate operation via the adjustment wheel, the output shaft is coupled with the adjustment wheel and the rotor is uncoupled. For this application, suitable coupling mechanisms are sufficiently known from the state of the art. Thus, in particular, the coupling mechanism can be so fashioned according to known mechanisms such that the adjustment wheel is automatically disconnected from the rotor shaft, as soon as the actuator works in motor operation mode. Especially, a support mechanism is provided, which is so embodied and/or arranged that it holds the coupling mechanism in engagement with the adjustment wheel and the output shaft in the case of the separate actuation. A corresponding coupling mechanism is already used in the actuators of the Series SA 6 to SA 100 of the assignee.

In an advantageous further development of the actuator of the invention, at least one current measuring unit is provided for registering the motor current. Using the measured current values delivered by the current measuring unit, the control regulates/controls the torque transferred from the drive unit to the valve.

A preferred embodiment of the actuator of the invention assures the sealing of the interior of the housing of the actuator relative to the process, or the environment, as the case may be. To this end, a first seal is provided in the first end region of the output shaft, and at least one second seal is placed in the second end region of the output shaft.

### BRIEF DESCRIPTION OF THE DRAWINGS

The invention will now be explained in greater detail on the basis of the drawings, the figures of which show as follows:

FIG. 1 a longitudinal section through a first form of embodiment of the actuator of the invention, with the upper and lower sections of the drawing showing the different operating states, motor operation and separate operation via the adjustment wheel;

FIG. 2 a longitudinal section through the form of embodiment shown in FIG. 1, in the case of motor operation;

FIG. 3 a longitudinal section through the form of embodiment shown in FIG. 1, in the case of separate operation via an adjustment wheel; and

FIG. 4 a schematic representation of a second form of embodiment of the actuator of the invention.

### DESCRIPTION OF THE PREFERRED EMBODIMENTS

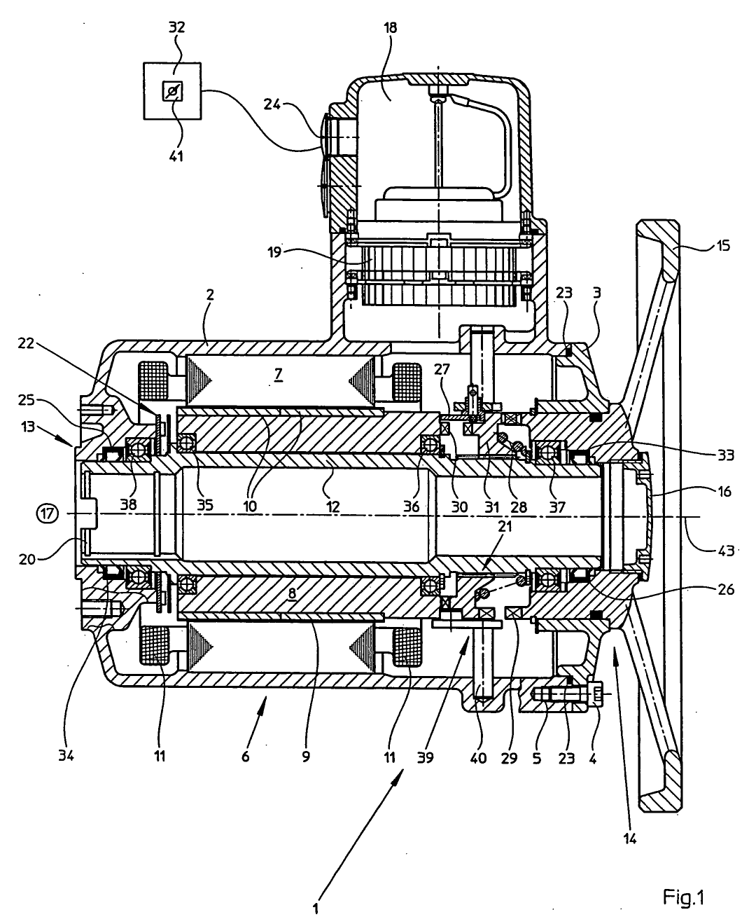

FIG. 1 shows a longitudinal section through a first form of embodiment of the actuator 1 of the invention. The actuator 1 is distinguished by a very compact form of construction. By omitting the reduction transmission, an increased stiffness of the actuator 1 is achieved. As a consequence, the actuator 1 of the invention is suited for highly accurate positioning tasks; additionally, it tolerates high accelerations, which results in a shortened cycle time.

Essential components of the actuator 1 of the invention are the electric motor 6 and the separately—thus independently of the electric motor 6—operable adjustment wheel 15. The electric motor 6 includes an output shaft 12, a rotor 8 and a stator 7. In the left, first end-region 13 of the output shaft 12, a valve connection 20 is provided for the coupling of the actuator 1 to a valve 17 (shown symbolically in FIG. 1). Valve 17 is preferably a control element, e.g. a globe-, gate-, throttle- or butterfly-valve. The valve connection 20 can be embodied in any way. Various constructions of valve connections are available from the assignee.

Located in the right, second end-region 14 of the output shaft 12 is the adjustment wheel 15, which, in the illustrated case, is a manually operable, hand wheel. However, it is also possible to operate the adjustment wheel 15 automatically via any suitable actuating mechanism.

The illustrated electric motor 6 uses an internal rotor, in which case the rotor 8 rotates within the stator 7. Rotor 8 carries the magnet arrangement, which preferably comprises permanent magnets 10. Located on the stator 7 is the coil arrangement, with the coils 11. As already explained above, the invention is not limited to a specific motor type. In principle, any electric motor 6 can be used, provided that it can be directly coupled with the output shaft 12 and develops a high torque T at low rotational speeds and at standstill.

Rotor 8 is journalled on the output shaft 12 via the bearings 35, 36. The output shaft 12 is journalled in the housing 2 of the actuator 1 via the bearings 37, 38. Seals 25, 26, which are arranged in the grooves 33, 34 in the first end region 13 and in the second end region 14 of the actuator 1, seal the drive shaft 12 and the electric motor 6 against the housing 2 and, therefore, relative to the process or the environment. Located in the second end region 14 of the housing 2 is the cover 3, which is connected with the housing 2 via securement means 4 secured in the blind bores 5. Via sealing rings 23, especially, in this case O-rings, the cover 3 is sealed against the housing 2.

The actuator 1 additionally includes an electrical connection 18, which is arranged outside of the interior of the housing 2. In the electrical connection 18 is located a round plug 19. Actuators with an externally situated electrical connection 18 with round plug 19 are available from the assignee. A description of the round plug is presented in the patent application DE 100 58 107 A1 of the assignee.

Activation of the electric motor 6 for moving the valve into a desired position is accomplished by means of the control 32, with the aid of the output shaft position data supplied by the position sensor 22. Control 32 adjusts the motor current I, in order to obtain the torque T required for operating the valve 17.

The motor current I is detected by means of the current measuring unit 41. The current measurement in the current measuring unit 41 is accomplished, for example, by the measuring of a resistance, thus via a so-called current shunt. Alternatively, of course, also an inductive current converter or Hall sensors can be used for the current measurement. Control 32 is also connected with the electric motor 6 and the position sensor 22 by means of connection lines (not shown in detail in FIG. 1), which are led through the cable screw-fitting 24 of the electrical connection 18.

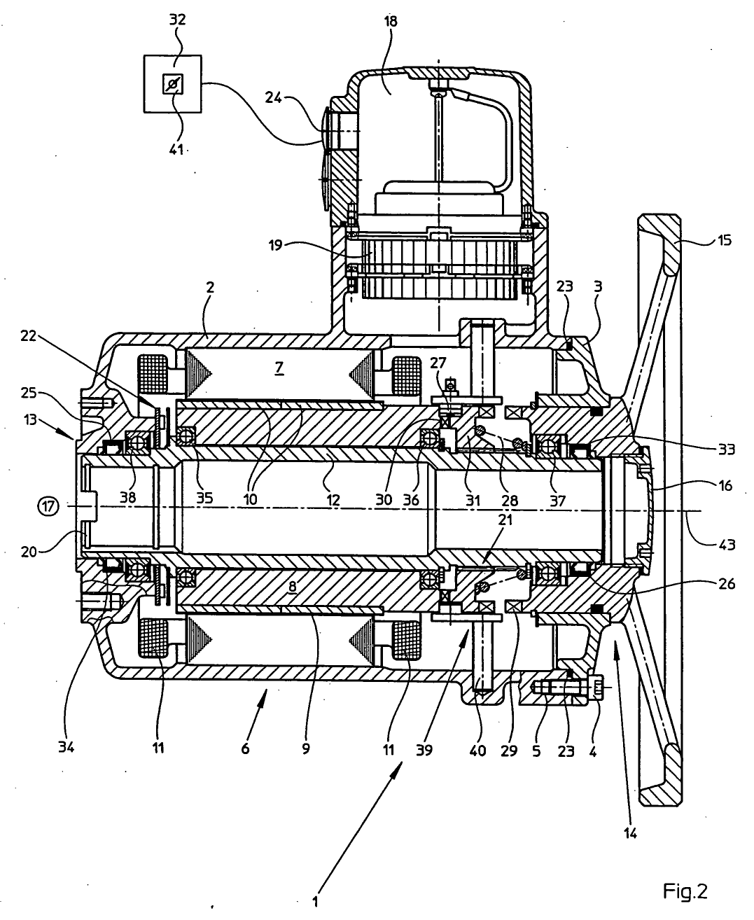

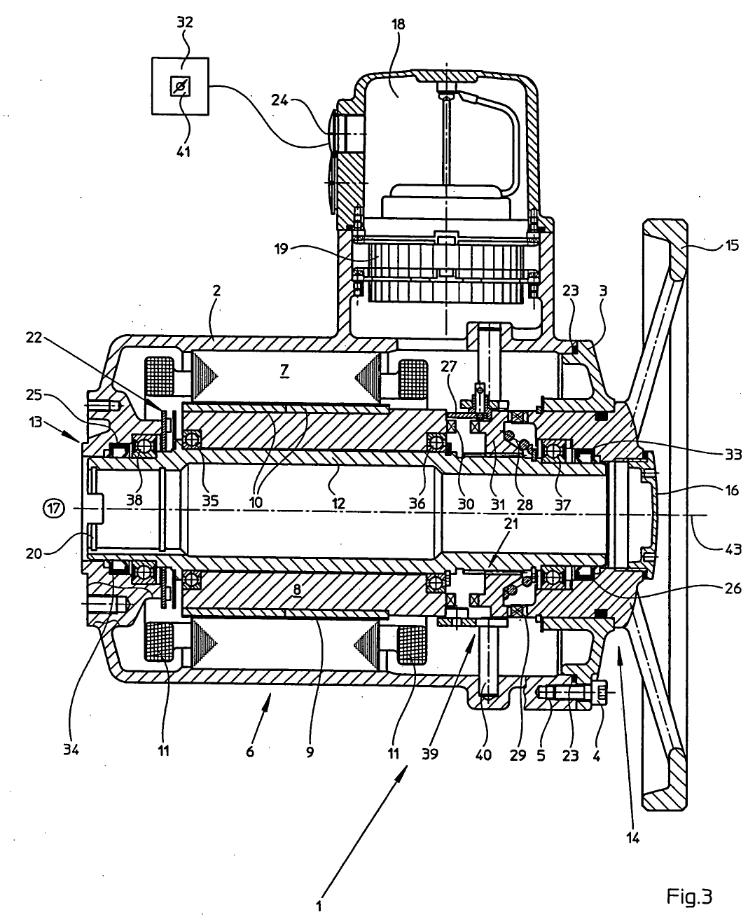

In FIG. 1, in the area above the longitudinal axis 43, the coupling mechanism is shown in the case of separate operation—here, thus, hand operation—, while the area below the longitudinal axis 43 shows the coupling mechanism in the case of motor operation. Then, for further clarification, FIG. 2 is completely dedicated to showing the actuator 1 of the invention in the motor operation mode, while FIG. 3 is, in turn, completely dedicated to showing the actuator 1 of the invention in the hand operation mode.

As already indicated, the coupling mechanism 21, composed of coupling 31, motor catch 30, adjustment wheel catch 29 and spring 28, is so embodied and arranged, that, in motor operation, the rotor 8 is directly coupled with the output shaft 12 and the adjustment wheel 15 is uncoupled; in the case of separate operation, the output shaft 12 is coupled with the adjustment wheel 15, and the rotor 8 is uncoupled. Via the support mechanism 27, here a hinged leg, the coupling mechanism 21 is held engaged with the adjustment wheel 15 and the output shaft 12, accompanied by pre-stressing of the spring 28, in the case of separate operation. Furthermore, the coupling mechanism 21 is embodied in such a manner that the adjustment wheel 15 is automatically uncoupled from the rotor shaft 12, as soon as the actuator 1 works in the motor operation mode. As soon as the rotor 8 rotates, the support bracket 27 is compelled to move out of the plane of the longitudinal shaft 43 and the pre-stressed spring 28 is released. The coupling 31 moves now into the output position. In this way, the adjustment wheel is uncoupled from the output shaft 12, while the rotor is simultaneously connected with the output shaft 12 via the coupling 31. In this way, it is assured that motor operation has preference over hand operation, i.e. over operation of the adjustment wheel 15 by means of a separate operating means.

As already mentioned, the actuator 1 of the invention exhibits an intrinsic self-locking, e.g. it has a certain locking torque. To achieve this, the control 32 short-circuits the coils 11 of the coil arrangement, in the case of the separate operation of the output shaft 12, or separate actuation of the valve 17, via the adjustment wheel 15. Rotor 8 is arranged on the output shaft 12 via bearings 35 36. Due to the rotation of the output shaft 12 via the adjustment wheel 15, the rotor 8 is dragged in accompaniment. This induces in the magnet arrangement a voltage, which exerts a torque on the rotor 8, which counteracts the torque transferred from the adjustment wheel 15 onto the output shaft 12.

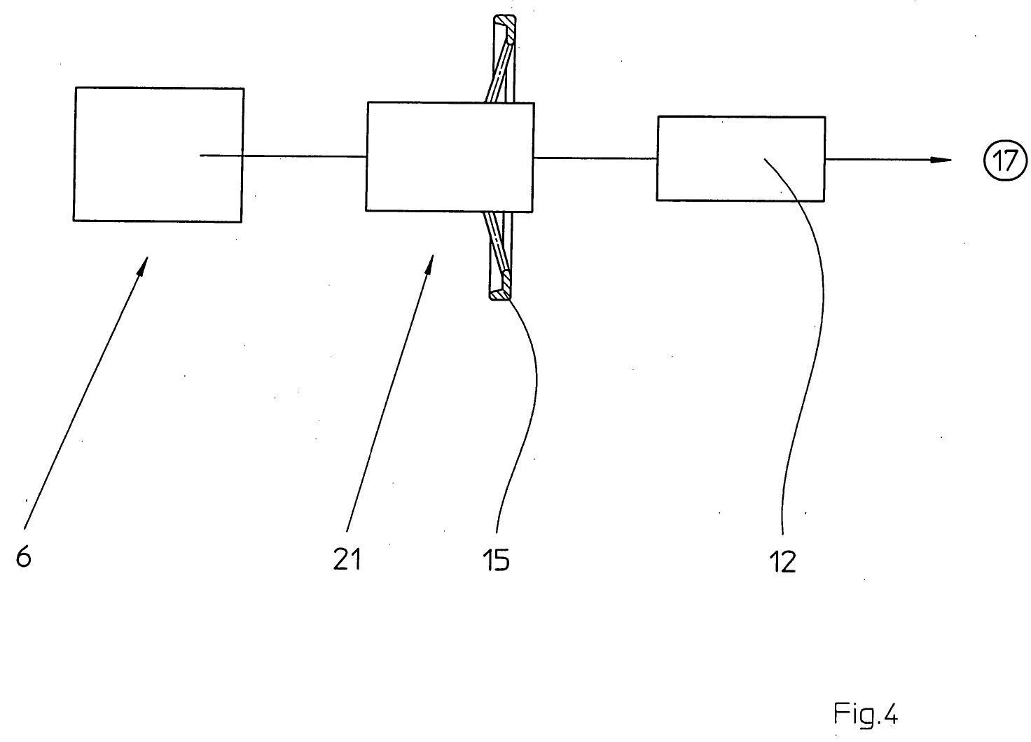

In the FIGS. 1 to 3, a form of embodiment of the actuator 1 of the invention is presented, in which the electric motor 6 is arranged on the output shaft 12. FIG. 4 provides a schematic presentation of a second form of embodiment of the actuator 1 of the invention, in which the electric motor is to the side of, or above, the output shaft 12. Here also, the output shaft 12 is coupled with the valve 17. The separately operable adjusting wheel 15 can be coupled and uncoupled via the coupling mechanism 21. The electric motor 6 is still arranged at the output shaft in this form of embodiment, but not, as in the previous form of embodiment, on, and rotationally symmetrically to, the output shaft.

1-14. (canceled)

15. An actuator for operating a valve in process automation, comprising:
a separately operable, adjustment wheel and;
an electric motor, including an output shaft, at least one stator and a rotor, wherein said stator and said rotor are associated with predetermined regions of said output shaft, said predetermined regions including a first region and a second region, wherein:
in said first end region of said output shaft, a valve connection is provided for coupling the actuator to the valve; and
said adjustment wheel is arranged in said second end region of said output shaft.

16. The actuator as claimed in claim 15, wherein:
said electric motor is an electric motor which can be directly coupled with said output shaft and which includes said rotor and said stator;
a coil arrangement is provided on said rotor or on said stator; and
said electric motor develops a high torque (T) at low rotational speeds (n) and at standstill.

17. The actuator as claimed in claim 15, wherein:
said rotor is an internal rotor.

18. The actuator as claimed in claim 15, wherein:
said rotor is an external rotor.

19. The actuator as claimed in claim 15, wherein:
said rotor is a disc rotor having at least one disc.

20. The actuator as claimed in claim 15, further comprising:
a position sensor associated with said output shaft.

21. The actuator as claimed in claim 20, wherein:
said position sensor is an absolute sensor or an incremental sensor.

22. The actuator as claimed in claim 21, further comprising:
a control, which drives said electric motor, or the valve, into a predetermined, desired position corresponding to information supplied by said position sensor.

23. The actuator as claimed in claim 22, wherein:
said electric motor further includes a coil arrangement;
said control short-circuits the coils of said coil arrangement in the case of a separate operating of said output shaft via said adjustment wheel.

24. The actuator as claimed in claim 15, further comprising:
a coupling mechanism which is embodied and/or arranged such that, in motor operation, said rotor is directly coupled with said output shaft and said adjustment wheel is uncoupled, and, in the case of a separate operation, said output shaft is coupled with said adjustment wheel and said rotor is uncoupled.

25. The actuator as claimed in claim 24, wherein:
said coupling mechanism is embodied in such a manner that said adjustment wheel is automatically uncoupled from said output shaft, as soon as the actuator works in motor operation.

26. The actuator as claimed in claim 24, further comprising:
a support mechanism, which is embodied and/or arranged such that it holds said coupling mechanism engaged with said adjusting wheel and with said output shaft in the case of a separate operation.

27. The actuator as claimed in claim 15, further comprising:
at least one current measuring unit for registering the motor current.

28. The actuator as claimed in claim 15, further comprising:
a first seal in said first end region of said output shaft;
at least one second seal in said second end region of said output shaft; and
both seals are so embodied and/or arranged that they seal the interior of the housing of the actuator relative to the process and relative to the environment.
